(19) United States
(12) Patent Application Publication
(10) Pub. No.: US 2005/0278955 A1
(43) Pub. Date: Dec. 22, 2005

(54) Knife having removable blade

(75) Inventor: Yung Jen Lee, Tali City (TW)

Correspondence Address: SHEPPARD, MULLIN, RICHTER & HAMPTON LLP, 333 SOUTH HOPE STREET, 48TH FLOOR, LOS ANGELES, CA, 90071-1448, US

(73) Assignee: Test Rite Products Corporation, Ontario, CA (US)

(21) Appl. No.: 11/156,222

(22) Filed: Jun. 17, 2005

(30) Foreign Application Priority Data
Jun. 22, 2004 (CN) 2004200661773

(51) Int. Cl. B26B 3/06; F41B 13/02

(52) U.S. Cl. 30/153

(57) ABSTRACT

A knife is provided having a blade that can be replaced easily without risk to the user, allowing the user to maintain positive control over the blade during replacement. In an exemplary embodiment, the knife includes a lock coupled to a blade holder. The lock extends through apertures of the blade holder to engage the blade. More particularly, the lock can move between an engaged position in which the lock engages a recess of the blade and a disengaged position in which the lock disengages the blade, allowing the blade to be removed. With the lock disengaged, a user can remove the blade while maintaining positive control over the blade.

### CROSS REFERENCE TO RELATED APPLICATION

This application claims priority to Chinese Application No. 2004200661773, filed Jun. 22, 2004, which is incorporated herein by reference.

### BACKGROUND OF THE INVENTION

The present invention relates generally to knives and, more particularly, to knives having replaceable blades.

In certain applications, a knife's blade can dull quickly. Thus, knives with replaceable blades are widely used. It advantageous for such knives to have a design that facilitates replacement of the blade. Various approaches have been used to this end.

Referring to FIGS. 1-3, a prior art knife is depicted that includes a handle 1 pivotally connected to a blade holder 2. The holder is configured to capture a blade 3 using a gate 4 and a clip 5 within a slot 21. Two bosses 22 are formed on the holder in the slot, aligned with recesses 31 of the blade. When the blade is put partially in the slot, the recesses receive the bosses. The gate is pivotally connected with the holder for keeping the blade in place. The clip is pivotally connected with the holder for keeping the gate in position.

Referring to FIGS. 2 and 3, several steps are required to replace a used blade. To remove the used blade, the clip must first be pivoted up. Then, the gate must be pivoted down. Thereafter, the blade can be removed from the holder and a new blade can be put in its place. Next, to keep the blade in position for use, the gate is pivoted up, and then the clip must be pivoted down to keep the gate locked in place.

Although such knives are generally effective, shortfalls exist. For example, since two separate pieces must be moved in sequence, it is difficult for users to maintain positive control of the blade, while installing or uninstalling a blade. Thus, there is a risk that the blade will fall out or that the user will be cut.

It should, therefore, be appreciated that there remains a need for a knife that obviates or at least alleviate the problems encountered in prior art. The present invention fulfills this need and others.

### SUMMARY OF THE INVENTION

The invention provides a knife having a blade that can be replaced easily without risk to the user, allowing the user to maintain positive control over the blade during replacement. In an exemplary embodiment, the knife includes a lock coupled to a blade holder. The lock extends through apertures of the blade holder to engage the blade. More particularly, the lock can move between an engaged position in which the lock engages a recess of the blade and a disengaged position in which the lock disengages the blade, allowing the blade to be removed. With the lock disengaged, a user can remove the blade while maintaining positive control over the blade.

In a detailed aspect of an exemplary embodiment, the blade holder defines a slot having an opening at a distal end thereof for receiving the blade. The lock is mounted on a first side of the holder and configured for movement transverse thereto.

In another detailed aspect of an exemplary embodiment, the lock and a control element are disposed on opposing sides of the blade holder. The control element is configured to move the lock between the engaged position and the disengaged position. The knife can further include a rod that extends through a passage defined by the holder to couple the lock and the control element together.

In yet another detailed aspect of an exemplary embodiment, the knife includes a handle attached to the blade holder, defining a recess for receiving the blade holder into a closed position.

In yet another detailed aspect of an exemplary embodiment, a plurality of rods can be used to couple the lock and the control element together.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a perspective view of a prior art knife, depicting a blade positioned to be installed on a blade holder.

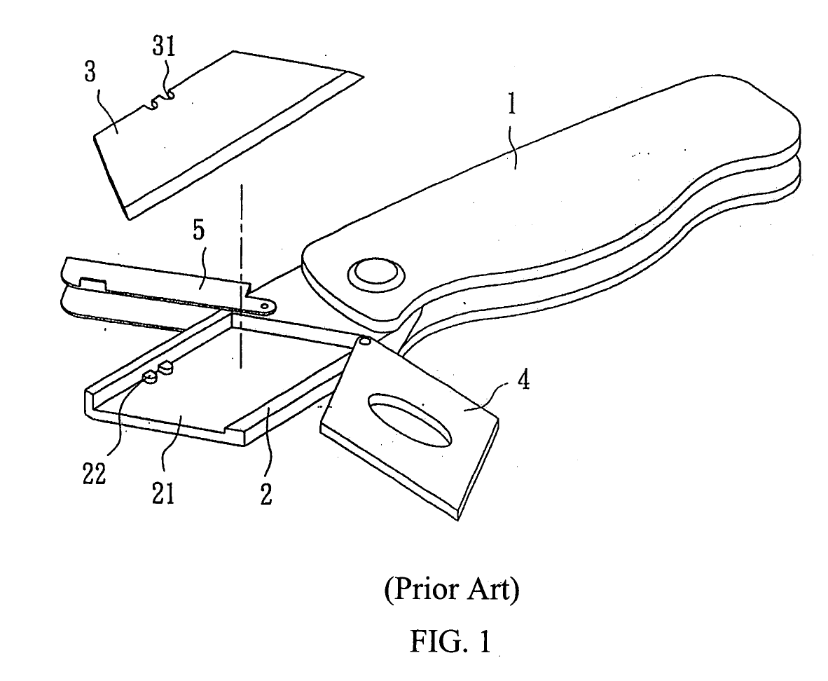

FIG. 2 is perspective view of the prior art knife of FIG. 1, depicting the blade in place with a gate and a clip of the knife in open positions.

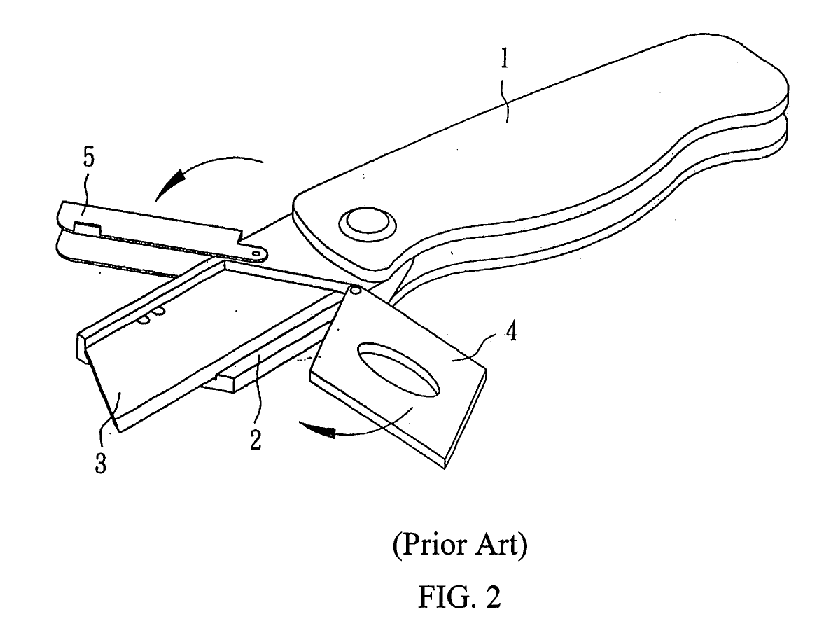

FIG. 3 is perspective view of the prior art knife of FIG. 1, depicting the blade in place with the gate and the clip in closed positions.

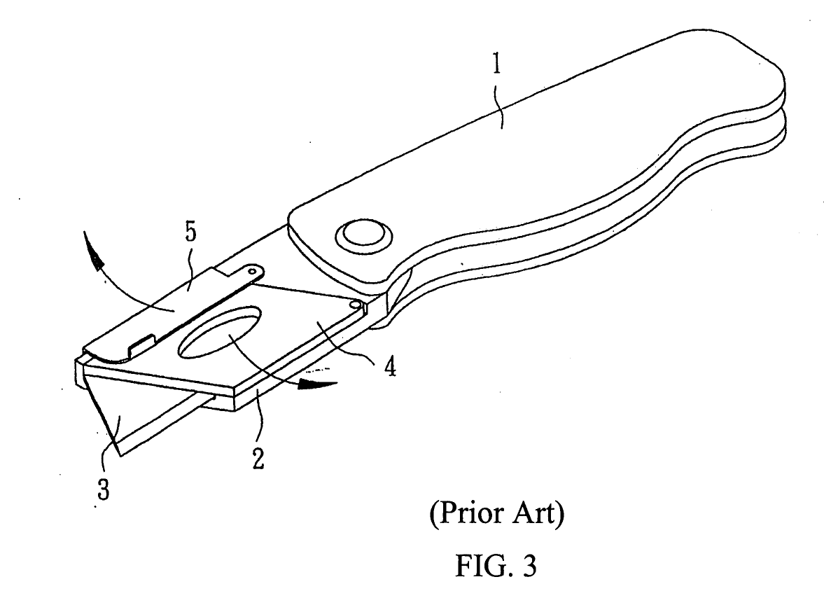

FIG. 4 is a partially exploded view of a knife in accordance with the present invention, depicting a removable blade aligned to be received with a slot of a blade holder.

FIG. 5 is a cross-sectional view of the knife shown in FIG. 4, excluding the blade.

FIG. 6 is a cross-sectional view, similar to FIG. 5, depicting a lock oriented in a disengaged position with the blade disposed in the slot of the holder.

FIG. 7 is a cross-sectional view, similar to FIG. 6, of the knife shown in FIG. 4, depicting the lock oriented in an engaged position with the blade disposed in the slot of the holder.

FIG. 8 is a perspective view of the knife shown in FIG. 4, depicting the blade disposed in the slot of the holder.

FIG. 9 is a cross-sectional view, taken along line 9-9 in FIG. 7, of the knife shown in FIG. 4, depicting the lock in the disengaged position for inserting the blade.

### DETAILED DESCRIPTION OF THE PREFERRED EMBODIMENTS

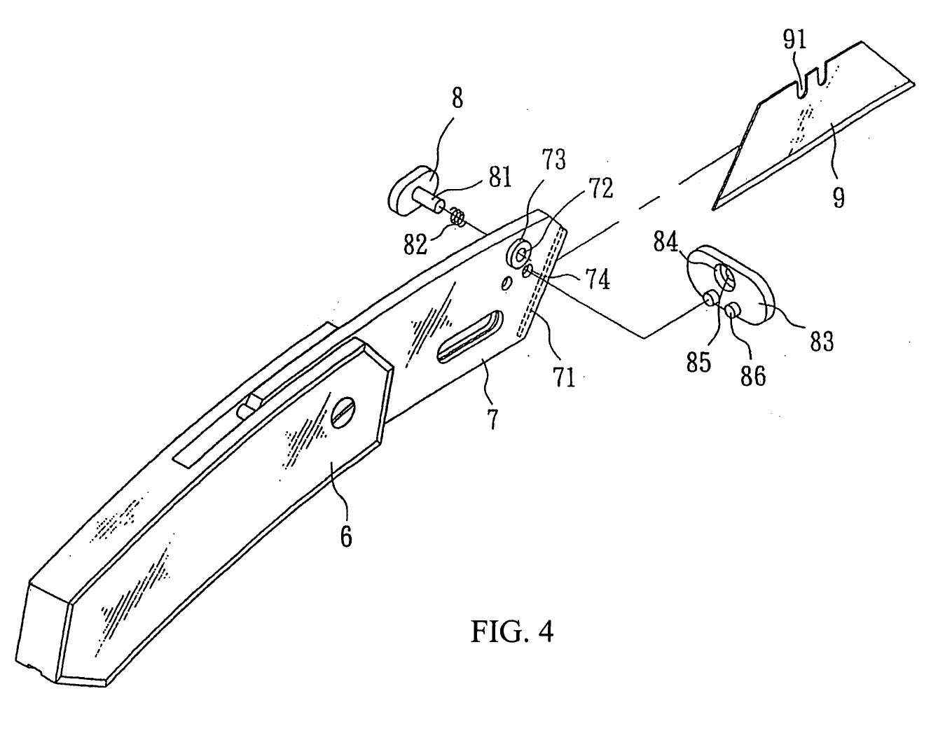

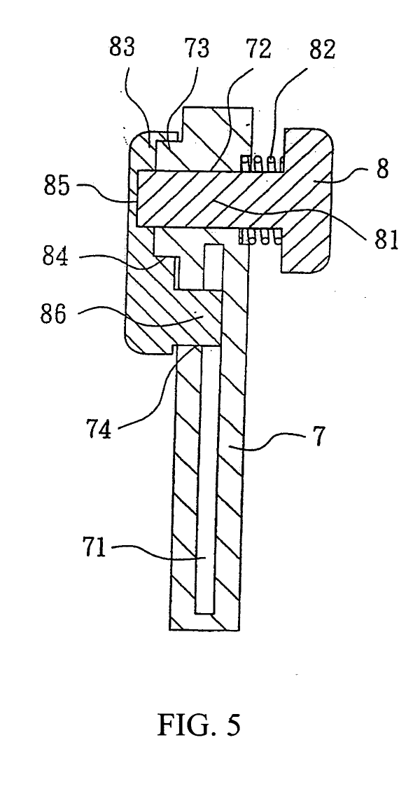

With reference now to the drawings, and particularly FIGS. 4 and 5, there is shown a knife having a blade holder 7 for receiving a removable blade 9 within a slot 71. The knife includes a lock 83 is disposed on a first side of the blade holder and is configured to extend through apertures 74 of the blade holder to engage the blade. More particularly, the lock can move between an engaged position in which the lock engages the recess of the blade and a disengaged position in which the lock disengages the recess of the blade, allowing the blade to be removed. The knife further includes a control element 8 disposed on a second side of the holder and configured to move the lock between the engaged position and the disengaged position. With the lock disengaged, a user can remove the blade while maintaining positive control over the blade.

The blade holder 7 defines two apertures 74 communicated with the slot 71 and aligned with recesses 91 of the blade 9, when disposed in the slot. The lock 83 includes two latches 86 that extend through the apertures to engage the blade via the recesses, when the lock is in the engaged position to secure the blade in place.

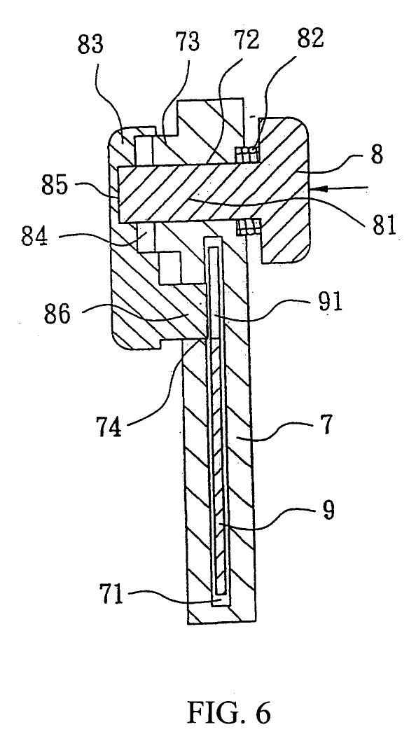

Referring to FIGS. 5 and 6, the lock 83 is operatively couple to the control element 8. The control element includes a rod 81 that extends through the passage 72 defined by the holder 7 to couple the lock and the control element together. The passage extends between the first and second sides of the holder, spaced apart from the slot 71; In the exemplary embodiment, the rod extends from the control element and is received in a bore 85 defined by the lock; however, in other embodiments, the rod can provided by the lock and attached to the control element. In other embodiments, a plurality of rods can be used to couple the control element and the lock.

The lock 83 is mounted about a guide 73 projecting from the first side of the holder, receiving guide in a hole 84 defined by the lock. The knife further includes a spring 82 disposed about the rod 81 to bias the lock 83 to the engaged position. By depressing the control element 8, a user can release the lock to remove the blade 9. In this manner, the lock moves transverse to the blade.

In the exemplary embodiment, the blade holder 7 is pivotally connected with the handle 6, and the handle defines a recess for receiving the handle in a closed position. A user can fold the holder into the recess, even with the blade in place. In other embodiment, various other handle configurations can be used. For example, the holder can be configured to displace axially into and out of a recess in the handle.

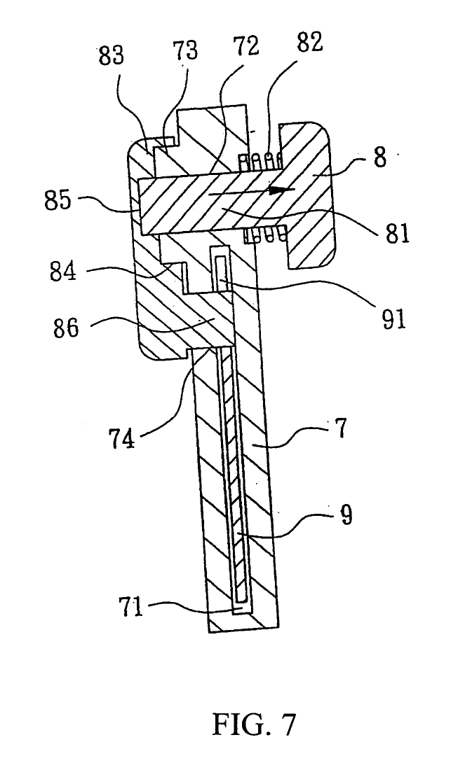

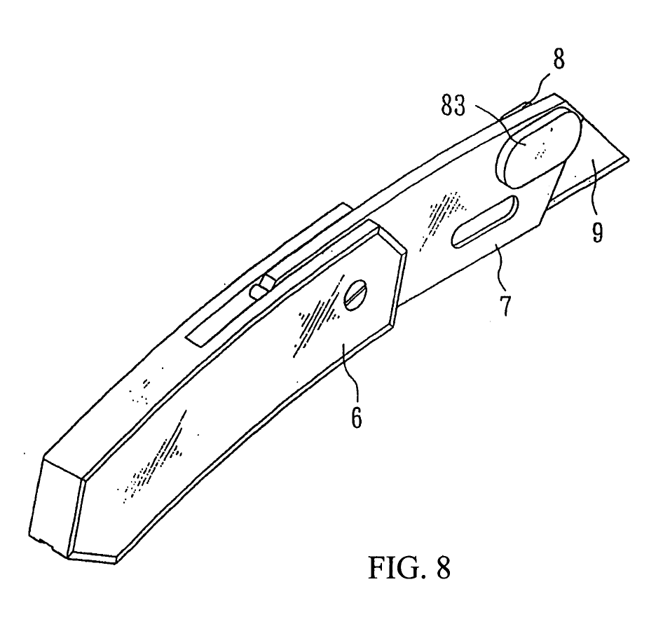

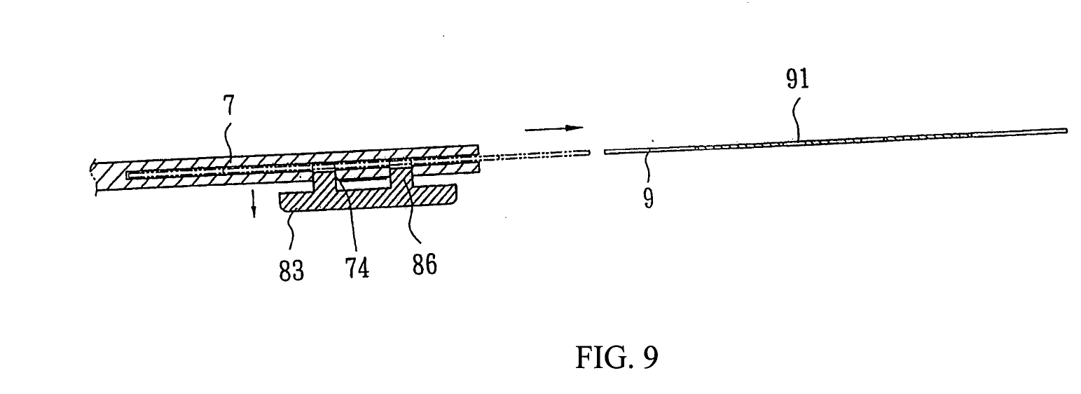

Referring to FIGS. 6 through 9, to insert the blade 9, the control element 8 is pressed, compressing the spring 8 and causing the lock 83 to disengage the blade. More particularly, the latches 86 are thereby withdrawn into the apertures 74, allowing the blade 9 to be inserted into the slot 71. Even with in this disengaged position, the hole 84 of the lock still receives the guide 73. Then, the control element 8 is released, causing the lock 83 to engage blade 9, locking the blade in place.

It should be appreciated from the foregoing that the invention provides a knife having a blade that can be replaced easily without risk to the user, allowing the user to maintain positive control over the blade during replacement. In an exemplary embodiment, the knife includes a lock coupled to a blade holder. The lock extends through apertures of the blade holder to engage the blade. More particularly, the lock can move between an engaged position in which the lock engages a recess of the blade and a disengaged position in which the lock disengages the blade, allowing the blade to be removed. With the lock disengaged, a user can remove the blade while maintaining positive control over the blade.

Although the invention has been disclosed in detail with reference only to the exemplary embodiments, those skilled in the art will appreciate that various other embodiments can be provided without departing from the scope of the invention. Accordingly, the invention is defined only by the claims set forth below.

1. A knife for use with a removable blade, the knife comprising:
a blade holder defining a slot for receiving a removable blade defining a recess, the blade holder defining an aperture aligned with the recess of the blade, when the blade is disposed in the slot;
a movable lock configured to extend through the aperture of the blade holder into the recess of the blade, the lock being movable between an engaged position in which the lock engages the recess of the blade and a disengaged position in which the lock disengages the recess of the blade, allowing the blade to be removed; and
a control element coupled to the lock such that the lock is biased to the engaged position.

2. A knife as defined in claim 1, wherein the blade holder defines an opening to the slot for receiving the blade at a distal end of the holder.

3. A knife as defined in claim 1, wherein the lock is oriented for movement transverse to the blade.

4. A knife as defined in claim 1, wherein the recess of the blade is an aperture defined in an intermediate region of the blade.

5. A knife as defined in claim 1, wherein the recess of the blade is defined along an upper edge of the blade opposing a cutting edge of the blade.

6. A knife as defined in claim 1, wherein the control element and the lock are disposed on opposing sides of the blade holder.

7. A knife as defined in claim 1, further comprising a handle attached to the blade holder, the handle defining a recess for receiving the blade holder into a closed position.

8. A knife for use with a removable blade, comprising:
a blade holder defining a slot for receiving a blade defining at least one recess, the holder further defining at least one aperture communicated with the slot and aligned with the recess of the blade, when disposed in the slot;
a movable lock having at least one latch formed thereon, the lock being movable between an engaged position in which the latch engages in the recess of the blade through the aperture of the holder and a disengaged position in which the latch disengages the recess of the blade; and
a control element coupled to the lock so that the lock and the control element are located opposite sides of the holder, the control element configured to move the lock between the engaged position and the disengaged position.

9. A knife as defined in claim 8, further comprising:
a rod that extends through a passage defined by the holder to couple the lock and the control element together; and
a spring disposed between the control element and the lock such that the lock is biased toward the engaged position.

10. A knife as defined in claim 8, wherein the holder includes a guide projecting from a first side for receiving the lock.

11. A knife as defined in claim 8, further comprising a handle pivotally attached to a proximal end of the blade holder, the handle defining a recess for receiving the blade holder.

12. A knife as defined in claim 8, wherein the lock is oriented for movement transverse to the blade.

13. A knife as defined in claim 8, wherein the slot having an opening at a distal end of the holder for receiving the blade.

14. A knife as defined in claim 8, further comprising a plurality of rods to couple the lock and the control element together.

15. A knife for use with a removable blade, the knife comprising:
a blade holder having first and second sides, the holder defining a slot having an opening at a distal end of the holder for receiving a removable blade defining a recess, the blade holder further defining an aperture aligned with the recess of the blade, when disposed in the slot, and further defining a passage between the first and second sides, spaced apart from the slot;
a movable lock disposed on the first side of the blade holder, the lock configured to extend through the aperture of the blade holder, the lock being movable between an engaged position in which the lock engages the recess of the blade and a disengaged position in which the lock disengages the recess of the blade, allowing the blade to be removed;
a control element disposed on the second side of the blade holder;
a rod extending through the passage defined by the holder to couple the lock and the control element together; and
a spring disposed between the control element and the lock such that the lock is biased toward the engaged position;
wherein the control element is configured to move the lock between the engaged position and the disengaged position.

16. A knife as defined in claim 15, wherein the holder includes a guide projecting from a first side for receiving the lock.

17. A knife as defined in claim 15, further comprising a handle pivotally attached to a proximal end of the blade holder, the handle defining a recess for receiving the blade holder.

18. A knife as defined in claim 15, wherein the recess of the blade is an aperture defined in an intermediate region of the blade.

19. A knife as defined in claim 15, wherein the recess of the blade is defined along an upper edge of the blade opposing a cutting edge of the blade.

20. A knife as defined in claim 15, further comprising a plurality of rods to couple the lock and the control element together.
